(19) United States
(12) Patent Application Publication
(10) Pub. No.: US 2003/0188442 A1
(43) Pub. Date: Oct. 9, 2003

(54) Snuff can opener

(76) Inventor: Kevin Imer, Etowah, NC (US)

Correspondence Address: WINSTON & STRAWN, PATENT DEPARTMENT, 1400 L STREET, N.W., WASHINGTON, DC, 20005-3502, US

(21) Appl. No.: 10/118,031

(22) Filed: Apr. 9, 2002

(51) Int. Cl. B67B 7/46

(52) U.S. Cl. 30/400; 30/1.5

(57) ABSTRACT

A can opener with top and circumferential support members attached to each other. A cutting blade is mounted to the circumferential support member and has a blade edge configured for cutting at least a portion of a circumferential can wall of a can. The top and circumferential support members are configured for guiding and the cutting blade along the circumferential can wall and for positioning at least a portion of the blade edge at an angle sufficiently small against the can wall for cutting at least a portion of the wall, while reducing or eliminating binding or tearing of said portion of the wall upon rotation of the can opener against the can by a user.

### FIELD OF THE INVENTION

The present invention relates to a can opener. More particularly, the invention relates to a hand held and operated can opener that can smoothly cut through a can wall or layer thereof, substantially without binding or tearing.

### BACKGROUND OF THE INVENTION

Traditional snuff cans have a plastic or cardboard cylindrical wall and bottom wall, and a metal or plastic lid. A lip of the lid extends parallel to and against the cylindrical wall and is sealed, such as by a wax coating in the interior and top edges of the cylindrical and bottom walls. A paper label is wrapped and adhered around the lid lip and the cylindrical wall to keep the can closed. To open the can, a user needs to peel away the paper label and lift or pry, and typically twist, the lid off the can. This is often accomplished using one's nails and teeth.

A snuff can opener is known with a flat portion that has a pie-slice shape, and with a semicylindrical portion holding sharply angled small serrations to cut the paper label. The serrations usually get caught in the paper and tear it roughly, making it difficult to cut the paper and severing the paper unevenly. The uneven tearing is not only unsightly, but also makes the lid hard to detach and does not produce evenly repeatable results.

A can opener is needed that can smoothly and repeatably open or assist in opening a can, such as a snuff can.

### SUMMARY OF THE INVENTION

The present invention relates to a can opener that is configured for enabling a user to open a can, such as a snuff tobacco can. A preferred embodiment of the invention comprises a top support member and a circumferential support member attached to the top support member. A cutting blade is mounted to the circumferential support member and has a blade edge configured for cutting at least a portion of a circumferential can wall of a can. The top and circumferential support members are configured for guiding and the cutting blade along the circumferential can wall. The support members position the blade so that at least a portion of the blade edge is at an angle sufficiently small against the can wall for cutting at least a portion of the wall while reducing or eliminating binding or tearing of this portion of the wall when a user rotates the can opener against the can. This angle is preferably at most about 30°. An attachment member may also be provided connected to the support members and defining an opening sized to attach to a key ring to provide for attaching the can opener to a set of keys and placed within a user's pocket.

The blade edge of this embodiment is substantially straight, and the portion of the wall that is cut is preferably a paper sheet. The blades are disposed, dimensioned, and configured for cutting the paper sheet and not cutting all the way through one or more other layers of the wall.

A preferred circumferential support member comprises an arcuate inner surface that substantially corresponds to the shape of the can. The circumferential support member extends circumferentially beyond the blade by at least about 5° for stabilizing the can opener against the can during cutting and also preferably has an outer surface textured for high traction against the user's hand in the direction of the rotation. This circumferential support member also has an angular length about a circumferential shape of about between 45° and 120°.

To improve cutting of the portion of the wall, the blade preferably includes an exposed abrasive material, such as diamond dust. The preferred top support member is generally flat and is disposed in relation with the blade for positioning the blade at a predetermined distance from an end of the can during the cutting. This predetermined distance is preferably about between 0.15 and 0.5 inches. In an embodiment, the blade comprises a plurality of blades displaced circumferentially from each other. The blade or blades preferably extend circumferentially over at least about a 10° angle.

In a preferred embodiment, the blades are displaced circumferentially from each other by an angular distance sufficient for enabling cutting of said portion of the wall during each of clockwise and counterclockwise rotation around the can to enable left and right handed use. Preferably, the blades include a first, second, and third blade. The second blade is disposed between the first and third blades for guiding at least one of the first and third blades during rotation of the can opener against the can and during cutting by said one of said blades.

Preferably, the blade edge is configured and located by the circumferential support member for contacting and cutting at least a portion of a circumferential can wall of a can that is disposed along a curved shape. A portion of the blade edge is oriented at angle to said curved shape of at most about 30°. In a preferred embodiment with a semicircular circumferential support member, the portion of the blade edge being oriented at angle of at most about 30° to the circumferential support member.

The present invention thus provides a hand held can opener that can easily be carried in a user's pocket and that can smoothly cut a portion of a can wall, such as the paper label that closes and provides a measure of sealing in a snuff can, or other type of can.

### BRIEF DESCRIPTION OF THE DRAWINGS

FIG. 1 is a bottom view of an embodiment of a can opener constructed according to the present invention;

FIG. 2 is a side cross-sectional view thereof taken along plane 11-11 of FIG. 1;

FIG. 3 is a side cut-away view thereof with a cross-sectional portion taken along plane III-III of FIG. 1, showing the can opener in the process of opening a can;

FIG. 4 is a bottom front perspective view of another embodiment of the invention; and

FIG. 5 is a rear top perspective view thereof.

### DETAILED DESCRIPTION OF THE PREFERRED EMBODIMENTS

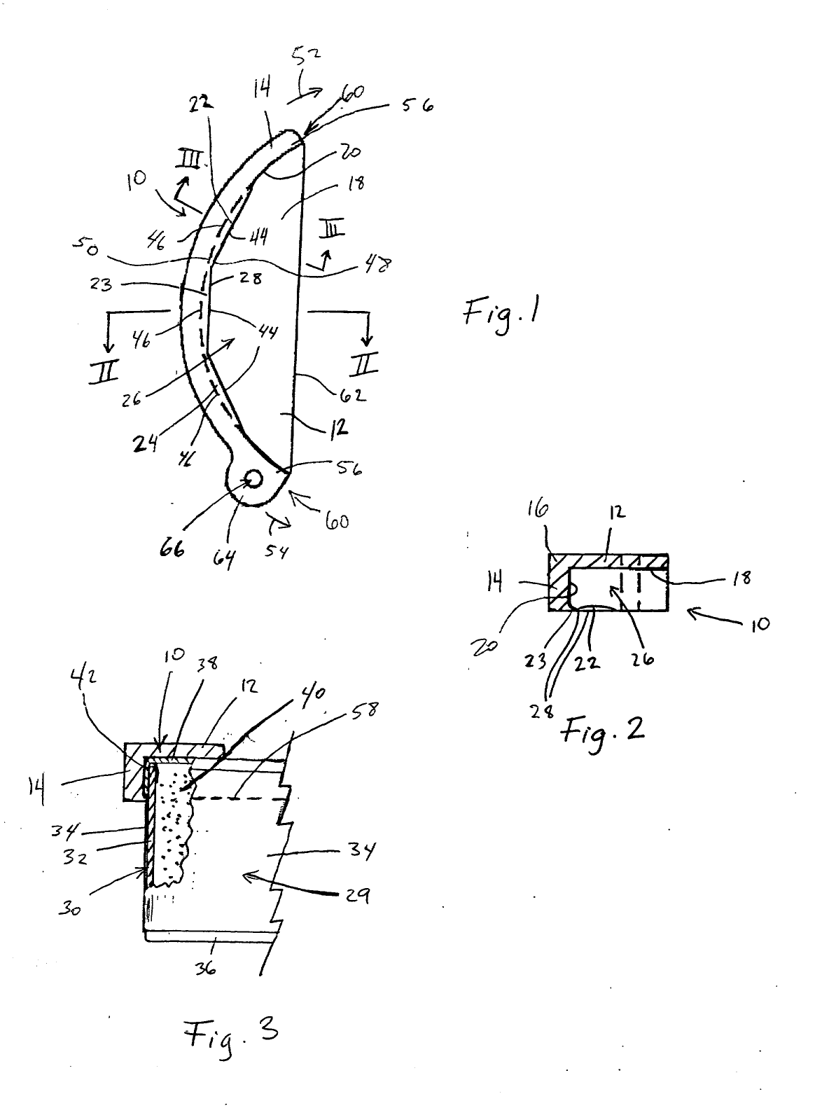

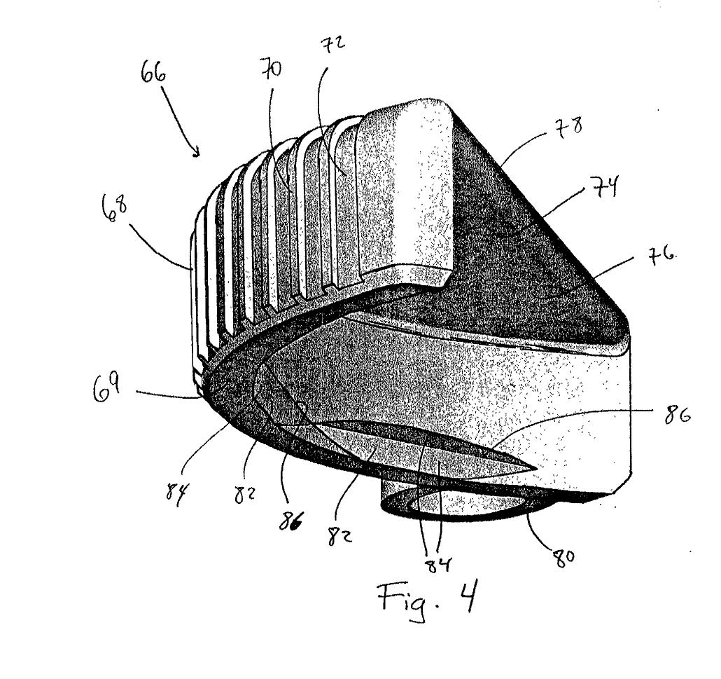

Referring to FIGS. 1 and 2, a preferred embodiment of the invention is a can opener 10 with top and circumferential support members 12,14. The preferred can opener 10 has no moving parts, although moving parts can be provided in alternative embodiments, and is manufactured as an integral piece. The top and circumferential support members 12,14 of the embodiment shown are attached to each other at edge 16, defining a can-receiving space 26 therebetween. Top and circumferential support members 12,14 are preferably of unitary construction.

Top inner surface 18 of the top support member 12 preferably extends at an angle to circumferential inner surface 20 of the circumferential support member 14, facing a can receiving space 26. The circumferential inner surface 20 preferably has an arcuate shape that substantially corresponds to the shape of the can. In an embodiment for opening a snuff can, the circumferential inner surface 20 is preferably semicircular, extending along less than half of a circle to facilitate placement against the side of the can, and has a radius of between about 1.3 and 1.4 inches, and most preferably around 1.34 inches. The preferred radius is substantially the same or slightly larger than that of the can intended to be opened. Other embodiments have radii of the circumferential inner surface 20 of about between 1 and 3 inches. The size of the can opener is preferably selected for holding and operating with a single hand, possibly with the other hand holding the can.

Cutting blades 22-24 extend inwardly toward the can-receiving space 26. The cutting blades 22-24 comprise blade edges 28 configured for cutting a circumferential can wall of a can. The blade edges 38 are preferably oriented substantially parallel with the axis of rotation during cutting, and are preferably parallel to the top inner surface 18.

As shown in FIG. 3, a preferred can 29 includes a can wall 30, which can include several layers. In the figure, the can wall 30 includes an inner, structural wall member 32, and an outer portion, such as a thin label 34 made sheet of paper, plastic, or metal. The can also has a bottom wall 36, which is preferably attached to the structural wall member 32 and may have a shoulder wrapped vertically therearound. A closure, such as a lid 38 is preferably associated with the wall 30 to close and seal the can and its contents 40. The contents 40 can comprise snuff, other forms of smokeless or other tobaccos, foods, or other products. The lid 38 has an lip edge portion 42 fitted over the structural wall member 32 and beneath the label 34, thus forming a portion of the wall 30 disposed between the structural wall member 32 and the label 34. An adhesive preferably attaches the label 34 to the lid 38 and structural wall member 32. The lid 38 is preferably made of a metal, such as tin, a paper, such as a cardboard, or a plastic, but may alternatively be made of other materials. The structural wall member 32 is preferably made of a rolled cardboard tube, but may alternatively be made of other materials, including a metal or a plastic and can be formed unitarily with the bottom wall 30.

The top and circumferential support members 12,14 are configured for locating the blades 22-24 at a predetermined distance below the top of the lid 38 and the top inner surface 18 of the top support member 12 and for guiding and the blade 22-24 along the circumferential can wall 30. At least one of the blades 22-24, and preferably at least two or all of the blades 22-24, is positioned so that the blade edges 28 are at an angle sufficiently small against the can wall 30 for cutting at least a portion of the can wall 30 while reducing or eliminating binding or tearing of the wall portion to be cut, upon substantially axial rotation of the can opener against the can by a user. Preferably, the blades 22-24 are positioned and configured for cutting through the label 34. In an alternative embodiment, however, the blades are positioned and configured for scoring or cutting this and other layers of the wall 30, and in one embodiment, the blades cut through a portion or all of a structural wall member of a can wall.

At a portion of the blade edges 28, preferably at the furthest point 44 on the blade edges 28 from the circumferential inner surface 20, the blades 28 are oriented at an angle of preferably at most about 30°, more preferably at most about 15°, and most preferably at most about 5°, to the circumferential inner surface 20 where the location 46 of the circumferential inner surface 20 located closest to the point 44. The angles to the circumferential inner surface 20 can also be measured to the phantom curve, which is preferably a circle, about which the blades are oriented and which is substantially coaxial with the can to be cut. Lateral portions 48 of the blades that are located within about preferably 20% and more preferably 10% from the lateral end of the blade edges 28 are oriented at an angle of preferably at most about 45°, more preferably at most about 30°, and most preferably at most about 20°, and preferably at least about 2° and more preferably at least about 5°0, to the circumferential inner surface 20 at the location 50 of the circumferential inner surface 20 located closest to the portion 48. In a preferred embodiment, the blades edges 28 are oriented to cut the wall 30 of the can at an incidence angle to the wall of preferably at most about 45°, more preferably at most about 30°, and most preferably at most about 20° or 10°, and preferably at least about 2° and more preferably at least about 5°.

The blade edges 28 of the preferred embodiments are smooth and not jagged, and are preferably not sharply pointed serrations, where they are positioned to come into contact with the can wall 30. The blade edges 28 are straight in the embodiments that are shown in the drawings, but in other embodiments can have a smooth and preferably slight concave or convex curvature. Preferably, the blade is oriented such that it has a portion that is substantially tangential to the circumferential inner surface 20 and/or the can wall 30 during use. Each blade preferably extends along at least about a 100 portion of the curved circumferential inner surface 20, measured about the axis thereof, more preferably along at least about 20°, and preferably at most about 40°. In an embodiment of the invention, the blade edges 28 extend along about a 30° portion of the circumferential inner surface 20. In this embodiment, the blades are double sided in that they are configured for cutting by rotating the can opener in either a clockwise or counterclockwise direction about the can, as shown in the drawings. In single sided blade embodiments, the angular extent of the blade edges can be smaller or halved compared to angular extent of the double sided blades.

Although a single blade can be used, the embodiment shown has three blades 22-24 that are displaced circumferentially from each other along the circumferential support member 14, preferably by an angular distance sufficient to enabling cutting of the portion of the can wall 30 during either clockwise or counterclockwise rotation around the can, so that the opener 10 can be used by right or left handed users. Pairs of nearest non-adjacent blades 22,24 are preferably positioned at more than about 20° from each other in a circumferential direction. Sequentially adjacent blades 22,23 and 23,24 can be disposed end to end, as in the embodiments shown, or can be spaced.

To operate the can opener 10, a user can hold that opener 10 with one or more fingers and, if desired, with a portion of the palm placed about the outside of the circumferential support member 14, with the top support member 12 placed against the lid 38. As shown in FIG. 1, the blades 22-24 are disposed and configured so that when the can opener 10 is rotated in direction 52, or counterclockwise when viewed from above, blade 24 is the principal cutting blade and performs the greatest cutting function due to the typical pressures asserted by the user, and the central blade 23 acts primarily as a guide, as it applies less pressure to the can wall 30. When rotated in direction 54, or clockwise when viewed from above, the majority of the cutting is done by blade 22, and again blade 23 acts as a guide.

The blades 22-24 are preferably made of a plastic, and are preferably of unitary construction with the rest of the can opener portions. A most preferred material for the can opener is high density polystyrene. The blades 22-24 can alternatively be made of a metal or other suitable material for cutting. Preferably, the blades comprise an abrasive material for improving the cutting of the label 34 or other desired wall portion. One preferred embodiment of the blades is made of a plastic with exposed diamond dust, preferably coated thereon, to improve cutting efficiency and durability.

The lateral ends 56 of the circumferential support member preferably extend beyond the outer edges of the blades 22,24 to stabilize the opener 10 against the can wall 30 during use. The lateral ends 56 preferably extend at least about 5° and at most about 45° beyond the outer blade edges, and preferably by about between 20° and 35°. The overall angular extent of the circumferential inner surface 20 and the circumferential support member 14 is preferably about between 30° and 120°.

As shown in FIG. 3, the preferred location for the blades 22-24 to cut the wall 30 is just below and adjacent the bottom edge 58 of the lid lip 42. The relation between the position of the blades 22-24 and the top support member 12 is selected to position the blades 22-24 at a predetermined distance below the top of the can 29. This distance is preferably about between 0.15 and 0.5 inches, and for a snuff can is preferably about between 0.25 inches and 0.35 inches, most preferably about 0.29 inches to the blade edge 28.

The preferred embodiment is sized to fit into a user's clothing pocket, and to save space, the top support member 12 has an edge 62 opposite from the circumferential support member 14 that extends generally straight between the lateral ends 60 of the circumferential support member 14. The edge 62 may alternatively have a curvature or bends that do not greatly increase the width of the can opener. The can opener preferably has a long dimension in the direction between ends 60 of the can opener that is preferably less than about 4 inches and more preferably less than about 3 inches. The width in a direction generally orthogonal to the longest dimension is preferably less than about 2 inches, and more preferably less than about an inch.

A key ring attachment 64 is provided in the embodiment shown, preferably located adjacent or at an end of the circumferential support member 14, although other locations can be suitable. The key ring attachment 64 defines an opening configured and dimensioned to receive and attach to a key ring or key chain, preferably smaller than about 0.3 inches.

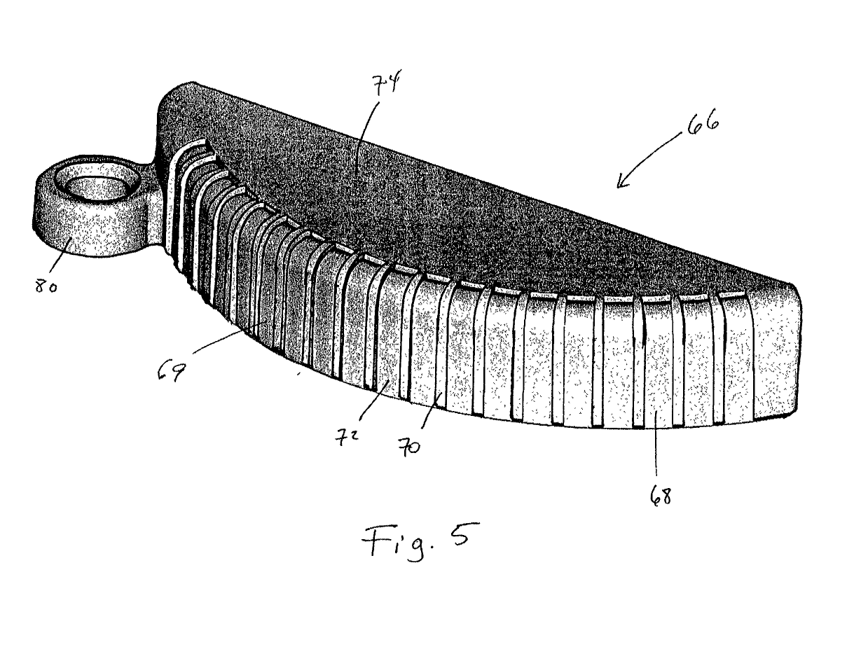

Referring to FIGS. 4 and 5, an alternative embodiment of the invention 66 includes a high traction, textured outer surface 68 on the outside of the circumferential support member 69, configured to improve the gripping traction against a user's hand to facilitate operation of the can opener. The textured surface of the embodiment shown includes a plurality of generally vertical ribs 70 spaced by grooves 72 extending substantially across the height of the circumferential support member 69 and onto the top support member 74. The ribs can have other orientations, but preferably cross the direction of rotation and are preferably not parallel thereto. Other textured surfaces include a roughened or gritty texture, although other embodiments can be smooth.

The top inner surface 76 of this embodiment has a rounded edge 78, curving away from the top inner surface 76 to facilitate placing of the can opener 66 on a can. A key ring attachment 80 is shorter than the height of the circumferential support member 69. Additionally, blades 82 of this embodiment have sloped surfaces 84 above and below the blade edges 86.

While illustrative embodiments of the invention are disclosed herein, it will be appreciated that numerous modifications and other embodiments may be devised by those skilled in the art. For example, the top and circumferential support members may have shapes such that they contact the can at a plurality of points instead of substantially equally along their extent. Also, the blades may be continuous with one another and may be segments of a single long blade and may have blade edges disposed at concave angles with respect to each other. Therefore, it will be understood that the appended claims are intended to cover all such modifications and embodiments that come within the spirit and scope of the present invention.

What is claimed is:

1. A can opener, comprising:
a top support member;
a circumferential support member attached to the top support member; and
a cutting blade mounted to the circumferential support member and having a blade edge configured for cutting at least a portion of a circumferential can wall of a can;
wherein the top and circumferential support members are configured for guiding and the cutting blade along the circumferential can wall and positioning at least a portion of the blade edge at an incidence angle sufficiently small against the can wall for cutting at least a portion of the wall while reducing or eliminating binding or tearing of said portion of the wall upon rotation of the can opener against the can by a user.

2. The can opener of claim 1, wherein the blade edge is substantially straight.

3. The can opener of claim 1, wherein the circumferential support member comprises an arcuate inner surface substantially corresponding to the shape of the can.

4. The can opener of claim 1, wherein the circumferential support member extends circumferentially beyond the blade by at least about 5° for stabilizing the can opener against the can during cutting.

5. The can opener of claim 1, wherein the circumferential support member comprises an outer surface textured for high traction against the user's hand in the direction of the rotation.

6. The can opener of claim 1, wherein the circumferential support member extends circumferentially by about between 45° and 120°.

7. The can opener of claim 1, wherein the blade comprises an exposed abrasive material for efficiently cutting said portion of the wall.

8. The can opener of claim 7, wherein the abrasive material comprises diamond dust.

9. The can opener of claim 1, wherein the top support member is generally flat and is disposed in relation with the blade for positioning the blade at a predetermined distance from an end of the can during the cutting.

10. The can opener of claim 9, wherein the predetermined distance is about between 0.15 and 0.5 inches.

11. The can opener of claim 1, further comprising an attachment member connected to the support members and defining an opening sized to attach to a key ring.

12. The can opener of claim 1, wherein:
the portion of the wall is a paper sheet; and
the blades are disposed, dimensioned, and configured for cutting the paper sheet and not cutting all the way through another layer of the wall.

13. The can opener of claim 1, wherein the incidence angle is at most about 30°.

14. The can opener of claim 1, wherein the blade comprises a plurality of blades displaced circumferentially with respect to each other.

15. The can opener of claim 1, wherein the blade extends circumferentially over at least about a 10° angle.

16. A can opener, comprising:
a top support member;
a circumferential support member attached to the top support member; and
a plurality of cutting blades mounted to the circumferential support member and having blade edges configured for cutting at least a portion of a circumferential can wall of a can;
wherein the top and circumferential support members are configured for guiding and the cutting blades along the circumferential can wall and positioning at least a portion of at least one of the blade edges at an angle sufficiently small against the can wall for cutting at least a portion of the wall while reducing or eliminating binding or tearing of said portion of the wall upon rotation of the can opener against the can by a user.

17. The can opener of claim 16, wherein the blades are displaced circumferentially from each other by an angular distance sufficient for enabling cutting of said portion of the wall during each of clockwise and counterclockwise rotation around the can to enable left and right handed use.

18. The can opener of claim 16, wherein said blades comprise first, second, and third blades, with the second blade disposed between the first and third blades for guiding at least one of the first and third blades during rotation of the can opener against the can while said one of said blades is cutting said portion of the wall.

19. A can opener, comprising:
a top support member;
a circumferential support member attached to the top support member; and
a cutting blade mounted to the circumferential support member and having a blade edge, the blade edge being configured and located by the circumferential support member for contacting and cutting at least a portion of a circumferential can wall of a can that is disposed along a curved shape, a portion of the blade edge being oriented at angle to said curved shape of at most about 30°;
wherein the top and circumferential support members are configured for guiding and the cutting blade along the circumferential can wall and positioning at least a portion of the blade edge against the can wall for cutting at least a portion of the wall while reducing or eliminating binding or tearing of said portion of the wall upon rotation of the can opener against the can by a user.

20. The can opener of claim 19, wherein the portion of the blade edge is oriented at angle of at most about 30° to the circumferential support member.
